(19) United States
(12) Patent Application Publication
(10) Pub. No.: US 2011/0071891 A1
(43) Pub. Date: Mar. 24, 2011

(54) TRACKING OF PEER CONTENT DISTRIBUTION

(75) Inventors: Edoardo Gavita, Laval (CA); Jonas Johansson, Saint-Laurent (CA)

(73) Assignee: TELEFONAKTIEBOLAGET L M ERICSSON (PUBL), Stockholm (SE)

(21) Appl. No.: 12/716,011

(22) Filed: Mar. 2, 2010

Related U.S. Application Data
(63) Continuation-in-part of application No. 12/627,789, filed on Nov. 30, 2009.
(60) Provisional application No. 61/243,811, filed on Sep. 18, 2009.

(51) Int. Cl. G06F 15/16; G06F 17/30; G06Q 30/00

(52) U.S. Cl. 705/14.16; 707/802; 707/758; 709/217; 707/E17.014; 707/E17.044

(57) ABSTRACT

Method and network node for enhancing tracking of peer distribution of a content in a network comprising receiving, from a first subscriber, a request to forward the content to a second subscriber, the request comprising a content identifier and logging in a record the content identifier and an identifier of the first subscriber and, optionally an identifier of the second subscriber. Optional aspects include, following the step of receiving the request, generating a license key related to the content and valid for the second subscriber, sending the license key towards the second subscriber and providing the content to the second subscriber. Other optional aspects include locating the record and providing an incentive to the first subscriber or adjusting a charging record of the content provider.

### PRIORITY STATEMENT

This non-provisional patent application claims priority based upon the prior U.S. provisional patent application entitled “USING DRM TO FINGERPRINT MESSAGES AND CAMPAIGNS”, application No. 61/243,811 filed Sep. 18, 2009, in the name of Jonas Johansson, the content of which is hereby incorporated by reference.

In addition, this non-provisional patent application, filed as a Continuation In Part (CIP), also claims priority based upon U.S. application Ser. No. 12/627,789, filed on Nov. 30^{th}, 2009, entitled “A METHOD, MOBILE AND NETWORK NODES FOR SHARING CONTENT BETWEEN USERS AND FOR TRACKING MESSAGES”, in the name of Jonas Johansson, assigned to the assignee of the present invention, the content of which is hereby incorporated by reference.

### TECHNICAL FIELD

The present invention generally relates to sharing and tracking messages in communication systems.

### BACKGROUND

Nowadays, since the penetration rate for mobile devices in many countries is high, the network operators in those countries need to introduce more and more Value-Added-Services (VAS) in order to maintain their number of clients/subscribers and continue to innovate and make money.

For example, the network operators can enter into partnership with different content providers, such as advertisement content providers and multimedia content providers, in order to offer VAS and promotions to their subscribers.

In such cases, a network operator can agree with an advertisement company, for example, to channel advertisements and other promotional material to its subscribers in exchange of a certain benefit.

Current solutions for this situation comprise a content provider which supplies a campaign (of advertisements and/or promotional material) to the network to be transmitted to a list of distribution (of subscribers) provided by the network operator. For each download of the advertisements and/or promotional material by a subscriber of the list, the network operator gets paid by a certain amount of money or other compensation, for example.

However, such solutions are not accurate in terms of tracking the messages of the campaign sent to the subscribers and thus it is not possible to obtain a good feedback of the campaign. Indeed, a subscriber, who has received the advertisements and/or promotional material, can decide to forward them to his/her friends, who are other subscribers of the network operator but not part of the distribution list, for example. In this case, the number of forwarded advertisements and/or promotional material is not counted and cannot be tracked. Especially, in a viral campaign where subscribers are encouraged to forward the content of the campaign, such as a promotional offer or a funny video/picture, to as many people as possible, using the current solutions, the success of the viral campaign will not be accurately measured.

Thus, there is a need for improving solutions about message/content sharing among subscribers and tracking the message/content.

### SUMMARY

A first aspect of the present invention is directed to a method for enhancing tracking of peer distribution of a content in a network. The method comprises steps of receiving, from a first subscriber, a request to forward the content to a second subscriber, the request comprising a content identifier of the content and logging, in a record stored in a memory of a repository, the content identifier and an identifier of the first subscriber. Optionally, the record further comprises an identifier of the second subscriber

The method may further comprise steps of, following the step of receiving the request, generating a license key related to the content and valid for the second subscriber, sending the license key to the second subscriber and providing the content to the second subscriber, wherein the step of logging is performed following the step of generating.

As another option, the method may further comprise steps of locating the record in the repository comprising the identifier of the first subscriber and following the step of locating, providing an incentive to the first subscriber.

Examples of incentive provided to the first subscriber comprise
a) giving customer loyalty points to the first subscriber;
b) crediting a charging record of the first subscriber in the network;
c) increasing a data threshold of the first subscriber in the network;
d) decreasing a data consumption account of the first subscriber in the network;
e) associating the first subscriber to a higher Quality of service (QoS) profile in the network;
f) modifying a data charging rate for the first subscriber in the network;
g) modifying a voice charging rate for the first subscriber in the network;
h) allowing access to a restricted service to the first subscriber, wherein the restricted service is offered through the network by the content's provider; or
i) waiving an account restriction for the first subscriber in the network.

The method may also comprise a step of sending at least one message to perform at least one of a) to i).

In another alternative, the method further comprises step of locating at least n records in the repository, the record being comprised in the n records. Each of the n records comprises at least the identifier of the first subscriber or has been logged because of the request to forward. Following the step of locating, a further of providing an incentive to the first subscriber may be performed.

In yet another alternative, the method further comprises steps of before the step of receiving, obtaining the content produced by a content provider, following the step of logging, locating the record in the repository comprising the content identifier and following the step of locating, adjusting a charging record of the content provider in the network. The step of adjusting the charging record of the content provider may be performed taking into account that the record comprises the identifier of the first subscriber.

Before the step of receiving the request to forward from the first subscriber, the method may also comprise a step of obtaining the content by the first subscriber from one of the content' provider or a third subscriber of the network.

A second aspect of the present invention is directed to a network node for enhancing tracking of peer distribution of a content in a network. The network node comprises a network interface for receiving, from a first subscriber, a request to forward the content to a second subscriber and a repository for logging in a record a content identifier, an identifier of the first subscriber. The request to forward comprises the content identifier of the content. The record may comprise an identifier of the second subscriber

The network node may further comprise a Rights Management (RM) module for following reception of the request, generating a license key related to the content and valid for the second subscriber. Logging the record may be performed following generating the license key.

The network node may also further comprise a Correlating Module for locating the record in the repository comprising the identifier of the first subscriber and following locating the record, providing an incentive to the first subscriber. At least one message may be sent through the network interface towards another network node to provide the trigger the incentive.

The Correlating Module may alternatively be used for locating at least n records in the repository, the n records comprising the record. Each of the n records may comprise at least the identifier of the first subscriber or may have been logged because of the request to forward. Following locating the at least n records, the incentive may then be provided to the first subscriber.

The network interface may be further for obtaining the content produced by a content provider and the Correlating Module for: following logging of the record, locating the record in the repository comprising the content identifier and following locating the record, adjusting a charging record of the content provider in the network. Adjusting the charging record of the content provider may be performed taking into account that the record comprises the identifier of the first subscriber.

### BRIEF DESCRIPTION OF THE DRAWINGS

In the appended drawings:

FIG. 1 is a schematic view of a communication system in which embodiments of the present invention can be carried out;

FIG. 2 is a flow chart illustrating a method for sharing multimedia content between a first subscriber and at least one second subscriber, according to an embodiment of the present invention;

FIG. 3 is an example of a first subscriber forwarding a multimedia content to a second subscriber according to an embodiment of the present invention;

FIG. 4 is a mobile node for sharing multimedia content between a first subscriber and at least one second subscriber, according to an embodiment of the present invention;

FIG. 5 is a flow chart illustrating a method for tracking messages in the communication system of FIG. 1, according to an embodiment of the present invention;

FIG. 6 is a network node for tracking messages in the communication system of FIG. 1, according to an embodiment of the present invention;

FIG. 7 is a flow chart illustrating a detailed method for tracking messages in the communication system of FIG. 1, in the context of a viral campaign, according to an embodiment of the present invention;

FIG. 8 is an exemplary modular representation of a network node for enhancing tracking of peer distribution of a content in a network in accordance with the teachings of the present invention;

FIG. 9 is an exemplary flow chart illustrating a method for enhancing tracking of peer distribution of a content in a network in accordance with the teachings of the present invention; and

FIG. 10 is an exemplary flow chart illustrating a detailed method for enhancing tracking of peer distribution of a content in a network in accordance with the teachings of the present invention.

### DETAILED DESCRIPTION

Generally stated, embodiments of the present invention allow for sharing multimedia content with other subscribers through the use of Rights Management (RM), such as Digital Rights Management (DRM). By so doing, the multimedia content can be tracked in terms of who downloaded and viewed/opened the multimedia content and how many times the multimedia content has been downloaded and viewed. For example, after a subscriber downloads the multimedia content, he/she can forward the multimedia content to a second subscriber. In order to open the multimedia content, both subscribers need to request a key, used by RM or DRM to protect the multimedia content, in order to unlock the downloaded or forwarded multimedia content. In the request, an ID from the subscriber, such as his/her Mobile Subscriber ISDN (MSISDN), can be provided, for example.

It should be noted that by multimedia content, it is meant any content or message comprising video, audio, image, text or a combination thereof.

The embodiments of the present invention are useful when applied to tracking a viral campaign, for example. A viral campaign usually comprises a message whose content is designed in such a way as to make people want to share it with others, i.e. it is intended to spread like a virus, in an infectious way. For example, the content of the message can comprise a video or image that is funny or a very attractive promotional material.

Using current solutions, it is possible to track how many recipients of the message of the campaign have downloaded it on their mobile device, for example. However, it is not possible to track how many recipients actually opened the message of the campaign, and how many recipients forwarded the message to others, who may subsequently open and/or forward the message. Furthermore, if the message of the campaign is shared or forwarded over Bluetooth or outside a network operator's Multimedia Messaging Service (MMS) domain, then, tracking of the message may become difficult. Indeed, in these situations, the recipient of the forwarded message generally needs to access a WAP browser and to support the reception of a WAP push for example, in order to unlock the content of the forwarded message. If not, then tracking is not possible for this forwarded message.

In case the campaign involves paying the network operator for each message opened by a subscriber, it is not possible to generate a report to accurately charge for this campaign through the current solutions. Furthermore, it is not possible to retain any demographic data of the campaign once the campaign is over. The embodiments of the present invention solve those problems and drawbacks.

An example of Rights Management (RM) is given by DRM. DRM has been introduced by Open Mobile Alliance 1.0 (OMA 1.0) and OMA 2.0 and allows generally for restricting distribution of downloaded contents, such as music, movies, games, etc. Also, DRM allows for forward lock, meaning that a downloaded content usually cannot be forwarded to other people/devices. A DRM module, according to OMA 1.0, usually comprises three components: an acquisition unit for receiving a content, a storage unit for storing the received content, and a first key generator which generates a key to encrypt the content as a media object having a content ID. Then, a right object is also generated by the DRM module, for specifying the rights and conditions of use of the media object. The key used to encrypt the media object is put into the right object. The right object also contains the content ID to the media object for which the rights apply. The DRM module may also comprise a second key generator for generating a license key, used to encrypt the right object, for example. This license key allows ultimately for unlocking the content. More specifically, for each DRM-protected content (media object), the second key generator generates a license key for each device that requests to view the protected content. It should be noted that there exists several implementations about how the DRM module protects a multimedia content and how to unlock the protected multimedia content. For example, the generation of the keys can be content based, device based, a combination of both, etc.

Furthermore, through RM or more specifically DRM protection, each protected content of a campaign is identified by a content ID, for example. RM and DRM are well-known in the art and thus will not be describer further.

However, in order to solve the above-mentioned problems and drawbacks about accurately tracking messages of a campaign, RM can be applied in such a way as to allow for tracking messages of a campaign, such as a viral campaign, through the correlation of an ID of the subscribers with the forwarded and opened messages and with their corresponding license keys generated by a RM module, such as a DRM module, as will be described hereinbelow.

It should be noted that in the embodiments of the present invention, DRM will be used as an example of RM. However, other kinds of RM can be used as well and are within the scope of the present invention.

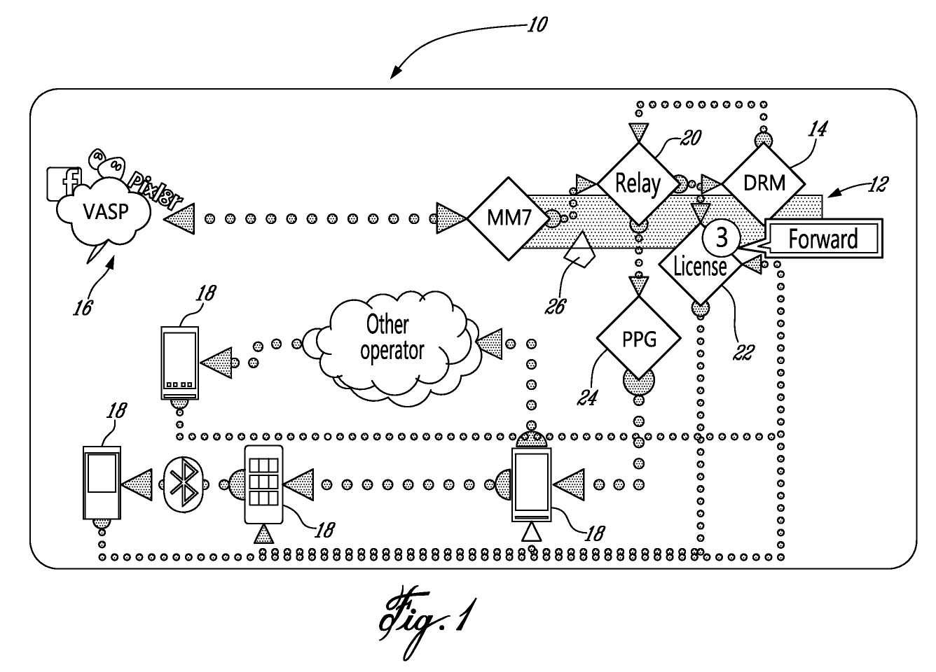

Now, turning to FIG. 1, an exemplary schematic high-level view of a communication system 10 will be described.

More specifically, FIG. 1 shows that the communication system 10 comprises a Multimedia Messaging Center (MMC) 12 for providing Multimedia Messaging Services (MMS). The MMC 12 may include a RM module, more specifically a DRM module 14 for protecting multimedia contents passing through the MMC 12. However, it should be noted that the DRM module 14 can be located inside the MMC 12 or located outside the MMC 12 in another network node (not shown) or can be even a stand-alone unit, in communication with the MMC 12.

The MMC 12 can further comprise a relay 20 (or a traffic node), and a license server 22. The relay 20 is connected to the DRM module 14 and the license server 22.

The MMC 12 may also comprise a correlating module 26, according to an embodiment of the present invention and which will be described hereinbelow.

The MMC 12 is connected to a content provider 16 on one end and is connected to mobile devices 18 on the other end.

In particular, the MMC 12 is in charge of receiving multimedia contents from the content provider 16, using the interface MM7 for example, and transmitting the multimedia content to the mobile devices 18.

When the MMC 12 receives a multimedia content, it is passed to the relay 20. If the multimedia content of the content provider 16 does not need to be protected through DRM, it is sent directly to a Push Proxy Gateway (PPG) 24, which pushes notifications to the mobile devices 18 to notify them of the multimedia content. However, if the multimedia content needs to be protected through DRM, for tracking purposes for example, then the relay 20 sends the multimedia content to the DRM module 14 in which the multimedia content is encrypted for protection. It should be noted that there exists several implementations of how the DRM module can protect a multimedia content. An example of protection is given hereinbelow. However, RM or DRM protection is not restricted to such an example. For instance, when protecting the multimedia content, the DRM module 14 encrypts the multimedia content so as to yield a media object, to which a corresponding content ID and right object are associated. Then license keys can be generated and assigned to the content ID. The generation of the license keys can be device based, meaning that a unique license key is generated for each mobile device 18 that requests for the license key. The unique license key generated for each mobile device 18 allows for unlocking the protected multimedia content identified by the content ID, through the right object, which contains a private key used to encrypt the multimedia content. The license keys can be pre-generated for each of the subscribers belonging to a list of distribution, based on the MSISDN of each subscriber, for example. Those license keys are then sent from the DRM module 14 to the license server 22 for distribution, through WAP Push for example, upon request of a mobile device.18. However, a license key can be also generated upon request of a subscriber, who is not part of the list of distribution but who has received a forwarded message, for example.

It should be noted that the DRM can use other ways to protect the multimedia content and the generation of the license keys can be content based, so that a single key is generated and used by all the mobile devices 18, for example.

Then, the protected multimedia content is distributed by the MMC 12 through the relay 20 to the list of subscribers, who first receive a notification from the PPG 24, for example. Alternatively, the protected multimedia content can be found on a web site and is ready to be downloaded by the subscribers/users.

When the subscribers receive the notification for the multimedia content, they may decide to download the protected multimedia content. In order to open or unlock the protected multimedia content, they need to request a corresponding license key. If the subscribers subsequently forward the protected multimedia content to other subscribers, those ones also need to request their corresponding license key. When granting or requesting the corresponding license keys through the license server 22, a correlation is made in the correlating module 26, between the license keys and the multimedia content of the campaign (through its content ID) and the ID of the subscribers so as to track the multimedia content of a campaign properly, as will be described hereinbelow.

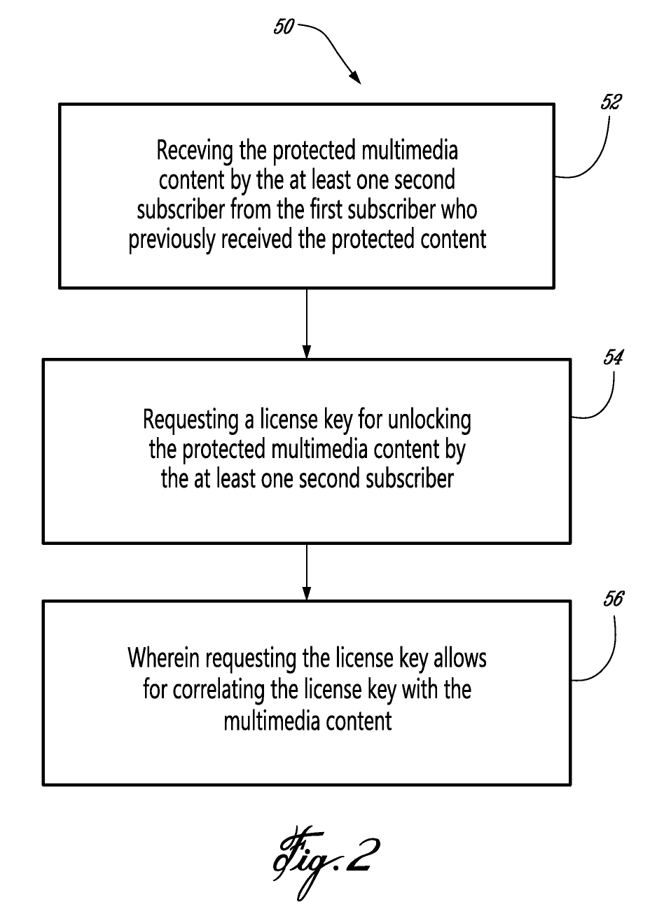

Now, turning to FIG. 2, a method 50 for sharing multimedia content protected by RM by a first subscriber with at least one second subscriber of a communication system, such as the communication system 10 of FIG. 1, will be described. As mentioned hereinabove, DRM protection is given as an example. DRM protection has been described hereinabove. The protected multimedia content can be unlocked through a license key, generated based on each device that asks for the license key, for example.

Method 50 starts with step 52 where the at least one second subscriber receives the protected multimedia content in his/her mobile device 18, for example. The at least one second subscriber receives the protected multimedia content from the first subscriber, who could have downloaded the multimedia content from a web site for example, or could have previously received it through the MMC 12, which had received the content from the content provider 16.

In order to open the received protected multimedia content, the at least one second subscriber needs to request a corresponding license key, from the license server 22, which was generated by the DRM module 14 of FIG. 1, for unlocking the received multimedia content. Thus, in step 54, the at least one second subscriber requests for the license key. Furthermore, in the request, the ID of the second subscriber, such as the MSISDN is provided.

In step 56, through the step of requesting for the license key, a correlation is made between the license key and the multimedia content, in the correlating module 26.

The first subscriber also needs to request a corresponding license key for unlocking the multimedia content that he/she first received. He/she can first request the corresponding license key, before forwarding the multimedia content to the second subscriber, or the first subscriber can first forward the multimedia content to the second subscriber and then request the corresponding license key for unlocking its received multimedia content.

Once the second subscriber receives the forwarded multimedia content, he/she can right away request the corresponding license key for unlocking the multimedia content or he/she can further forward the multimedia content to at least a third subscriber (or other subscribers) and then ask for the corresponding license key from the license server 22, for example.

Alternatively, in order to enhance the subscribers or end users' experience, it is also possible to send the corresponding license key ahead of the multimedia content in the communication system 10. For example, before the MMC 12 sends out the multimedia content of a campaign to the first subscriber, the corresponding license key used to unlock the protected multimedia content can be first sent to the first subscriber. When the multimedia content later arrives to the first subscriber, the mobile device 18 of the first subscriber can see that it has a matching/corresponding license key and thus can unlock the multimedia content right away. In other words, the previously received license key can detect that it can unlock the newly received multimedia content. Therefore, in this case, the first subscriber does not need to request the license key, which can be helpful in cases where the first subscriber does not have data access on his/her mobile device 18.

It should be noted that in the above case, the corresponding license keys have been pre-generated by the DRM module 14 for the subscribers on the list of distribution, using a device-based generation for the license keys, for example. This is possible since the ID of the subscribers of the list is usually already known by the network or the MMC 12.

In the same manner, in his/her request for the license key, the first subscriber can also indicate his/her desire to forward his/her downloaded multimedia content to at least one second subscriber by providing the ID of the second subscriber. In this case, the DRM module 14 can decide to first generate the corresponding license key and send it to the at least one second subscriber, who then will receive subsequently the multimedia content from the first subscriber. Thus, the second subscriber does not need to request for the license key.

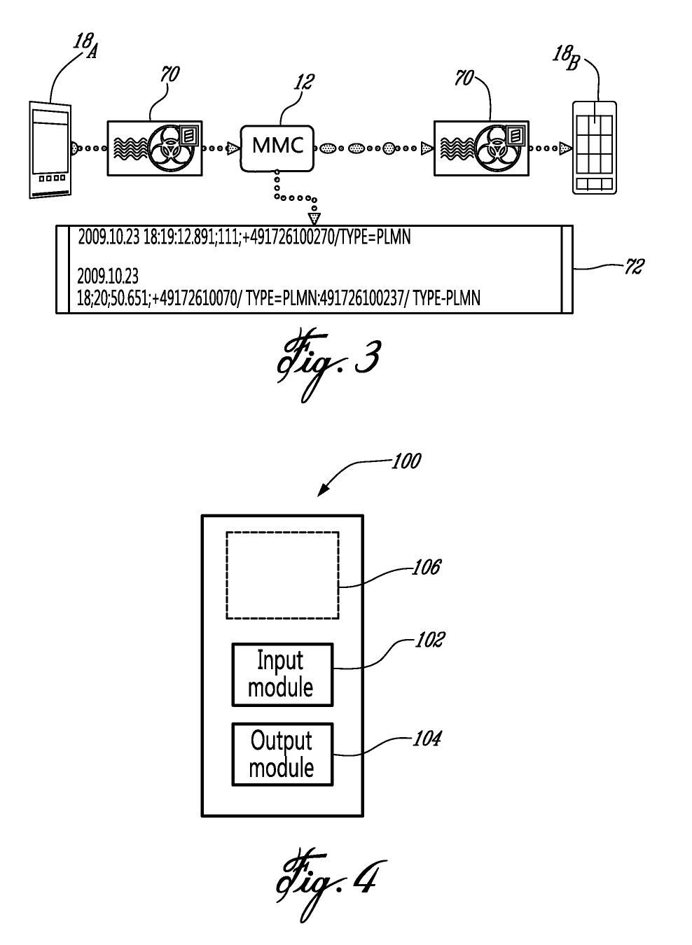

More specifically, FIG. 3 illustrates a detailed example of the first subscriber referred to as 18_{A} forwarding the multimedia content, as a MMS message 70, to the second subscriber 18_{B}.

When forwarding the MMS message 70 from the first subscriber 18_{A} to the second subscriber 18_{B}, the MMS message 70 goes through the MMC 12. When the MMC 12 receives it, it reads the data in the header of the MMS message 70, such as the “To, From, Time, Date” fields and the content ID. The header can be a Multipurpose Internet Mail Extensions (MIME) header. Then, the correlating module 26 (not shown in FIG. 3) correlates the content ID of the multimedia content 70 with the campaign and the ID of the subscribers. Also, the MMC 12 logs in a repository 72 the recorded fields (“To, From, Time, Date”) and the content ID of the message of the campaign to be tracked, for example. Those data can be used in connection with other data for producing and creating different reports, files, statistics about the subscribers, the success of the campaign, etc.

Finally, the MMC 12 can decide to send the license key, through the license server 22, right away to the second subscriber 18_{B} so that when the MMS message 70 is delivered to him/her subsequently, he/she does not need to request for the corresponding license key. It should be noted that this step can be skipped if the network operator decides that each subscriber receiving the multimedia content should ask himself/herself for the corresponding license key.

More specifically, it should be noted that through the requesting/granting of the key, a correlation is made between each received and/or forwarded message (through their content ID), the ID of the subscribers and the corresponding license key. Indeed, when the first and second subscribers request for the license key, their ID, such as their MSISDN, is sent to the MMC 12.

This correlation allows for tracking the number of opened messages, including the forwarded messages and thus allows for measuring accurately the success of the campaign. Also, through the tracking, the list of distribution of subscribers can be tuned in order to determine the top subscribers who forward the most messages, for example. These top subscribers can then be rewarded by receiving credits, for example, and also be marked as good forwarders in the list of distribution. This information can be used as new inputs for further campaigns, especially in viral campaigns. For example, through the correlation, the number of forwards per MSISDN can be counted.

Furthermore, social graphs can be produced through the tracking of forwarded messages. For example, a graph can show the connection between subscribers through a sequence of message forwarding. Indeed, each time that a subscriber sends a request for the license key to unlock the multimedia content, the request contains an ID of the subscriber, such as the MSISDN. Also, when the MMC 12 receives a forwarded message, it records the “to field” which indicates to whom the multimedia content will be forwarded and the “from field” for indicating from whom the multimedia content came. The information can be recorded by the MMC 12, or the license server 22. The MMC 12 then generates a log repository having data such as “date, time, to, from, etc.” and stores them in a report.

It should be noted that other fields and methods can be used for providing the same information.

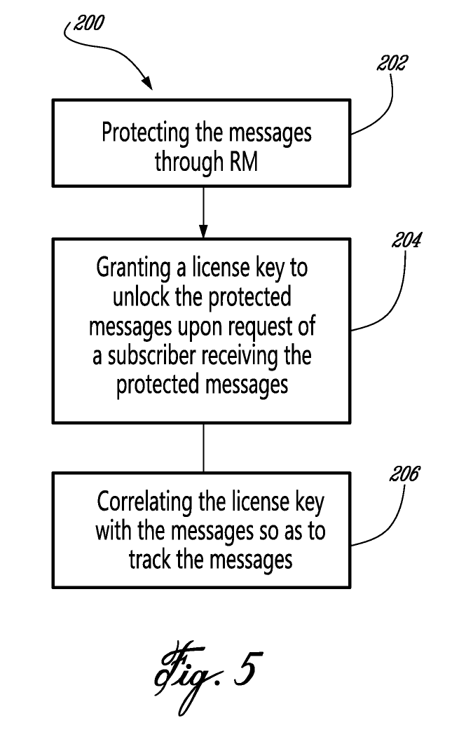

Now, turning to FIG. 4 and with reference to FIG. 1, a mobile node 100, such as the mobile device 18, for sharing multimedia content protected by RM or DRM by a first subscriber with at least one second subscriber in the communication system 10, for example, will be described.

The mobile node 100 comprises an input module 102 for receiving the protected multimedia content from the first subscriber. The first subscriber may have downloaded the protected multimedia content from a website or received it from the MMC 12 of FIG. 1. The mobile node 100 also comprises an output 104 for requesting a license key from the license server 22 for unlocking the protected multimedia content. As mentioned above, the license key can be also requested before the arrival of the multimedia content. In the request, the ID, such as the MSISDN, of the subscriber is provided. The input 102 then receives the license key, which is used to unlock the protected multimedia content. When providing the license key, a correlation is made between the license key, the ID of the subscriber and the multimedia content. Since the license key is correlated to the ID of the subscriber and the multimedia content (through the content ID), it is then possible to track or count the number of messages/multimedia contents that have been opened and forwarded.

It should be noted that the mobile node 100 may also comprise a screen 106 and a plurality of other components (not shown), such as a processor and/or memory, for performing tasks and procedures of the present invention and other usual tasks and procedures well known in the art.

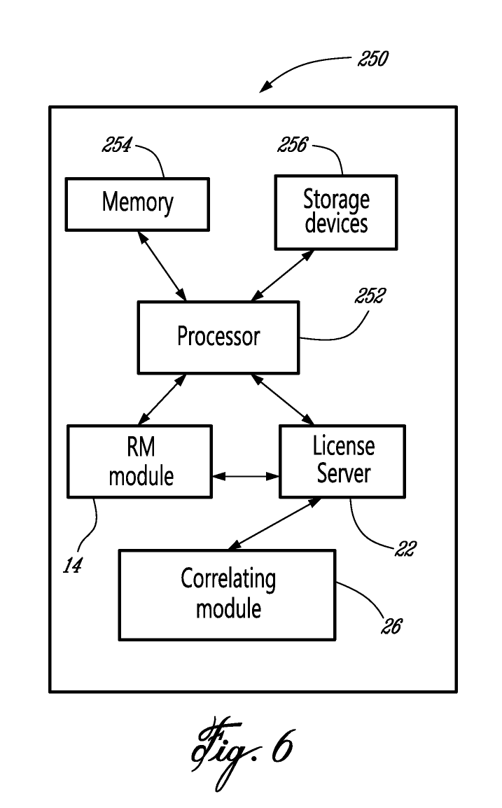

In FIG. 5 and with reference to FIG. 1, a method 200 for tracking messages in the communication system 10 is illustrated.

For example, messages from a campaign are submitted to the MMC 12 for distribution to a list of subscribers.

Once the MMC 12 receives the messages, method 200 starts with step 202 where the messages are protected through RM or more specifically DRM. In this case, the DRM module 14, when receiving a message, coming from the content provider 16, for example, encrypts the received message, and a content ID is assigned to the protected message. Once the messages are protected, they are sent out by the MMC 12 to a list of subscribers, through separate delivery according to OMA 1.0 or through super distribution according to OMA 2.0. Furthermore, as mentioned above, license keys can be generated by the DRM module 14 in order to unlock the protected messages, the license keys being generated based on each mobile device asking for the license key. The license keys are then transmitted to the license server 22.

When a subscriber receives the protected message, he/she can ask the license server 22 for the corresponding license key in order to unlock the content of the received message. In his/her request, his/her ID, such as the MSISDN, can be provided. Then, in step 204, upon receiving the request for the license key, the license server 22 grants the corresponding license key to the subscriber by sending it to him/her.

It should be noted that the license key can be given to the subscriber before he/she receives the message, as an alternative.

When granting the license key, a correlation is made between the license key and the message. Also a correlation between the license key and the subscriber through his/her ID is made. Thus, the granting of the license key to unlock the protected messages allows for tracking the messages of the campaign. Whether the subscriber receives the message from the MMC 12 or another subscriber, any open or forwarded message can be tracked through the license key acquisition. Therefore, the correct number of opened messages can be counted and an accurate picture of the success of a campaign can be determined, for example. Also, by correlating the license key with the ID of the subscribers, the list of distribution can be analyzed and subscribers who forward or open the most messages can be identified for further purposes and campaigns.

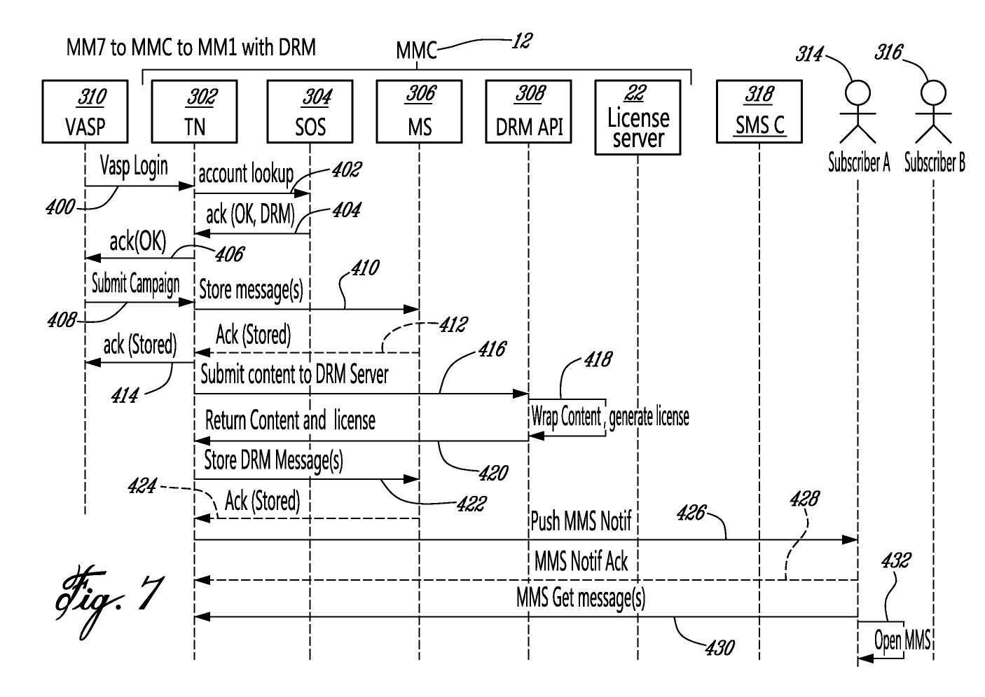

Now, turning to FIG. 6, a network node 250, for tracking messages in the communication system 10 will be described.

The network node 250 can contain a processor 252 (or multiple processor cores), a memory 254, one or more secondary storage devices 256, a RM module (or more particularly the DRM module 14), the license server 22 and a correlating module, such as the correlating module 26. The network node 250 can protect the messages of a campaign using the DRM module 14, as explained hereinabove, for example. The license server 22 allows for granting the corresponding license keys needed for unlocking the protected messages, upon request of the subscribers. The network node 250 can also correlate the granted license keys with the messages and the ID of the subscribers who ask for the license keys through the correlating module 26. This correlation allows for tracking the messages. The correlation can be used by the MMC 12 to further produce reports and statistics in terms of the number of downloaded messages and success of a viral campaign, for example.

Therefore, the network node 250 can perform the functions of a DRM module, a license server as well as correlating the key with the messages, as a single node. Alternatively, if these functions are split between various messaging nodes, the network node 250 can perform those functions as needed.

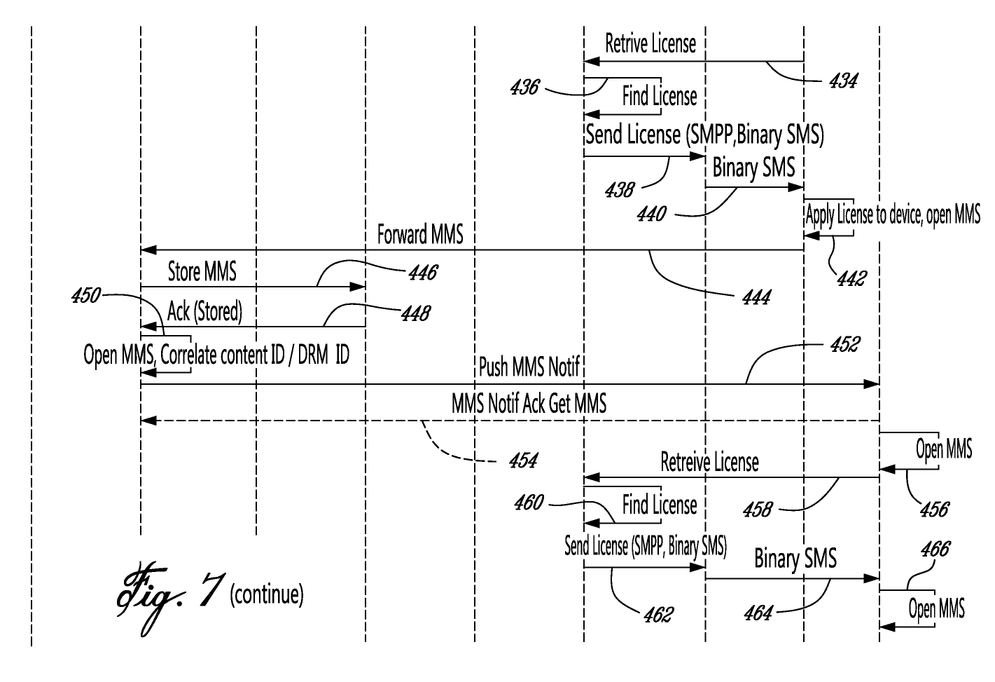

Now, turning to FIG. 7, a detailed example of method 200 for tracking messages in the communication system 10 will be described in the context of a viral campaign, launched by an advertising company, for example. It should be noted that other contexts can be also considered. In this example, DRM is used as one of the RM means. The content of the messages is protected by DRM. License keys are generated based on each mobile device for unlocking the protected messages. In another embodiment, the message is protected based on the content ID and a same key is generated for every mobile device 18, for example.

More specifically, the MMC 12 may comprise a Traffic Node 302 (such as the Relay 20), a subscriber database (SOS) 304 for storing information/profiles of the subscribers, a Message Store (MS) 306 for storing messages received from the campaign, an Application Programming Interface (API) 308 to the DRM module 14 (not shown in FIG. 7), and the license server 22 as described hereinabove.

First, the content provider 16 submits a viral campaign to the MMC 12. To do so, in step 400, the content provider 16, which can be represented generally by a Value-Added Service Provider 310, using for example the interface MM7, logs into the TN 302 of the MMC 12. Then, in step 402, the TN 302 asks the SOS 304 to do an account lookup to ensure that the content provider 16 is registered with the MMC 12. The SOS 304 checks the account and if it is ok, an acknowledgment is sent back to the TN 302 from the SOS 304, in step 404. Then, the TN 302 forwards the acknowledgment to the VASP 310 in step 406.

Upon receipt of the acknowledgment, the VASP 310 submits the viral campaign comprising a message such as a multimedia content, to the TN 302, in step 408.

Then, the TN 302 sends the message to the MS 306 for storage, in step 410. Once the message of the viral campaign has been stored, the MS 306 sends an acknowledgment to the TN 302 in step 412. The TN 302 then forwards it to the VASP 310 in step 414.

In step 416, the message of the viral campaign is sent to the DRM module 14 through the API 308. Upon receipt of the message, the DRM module 14 protects the content of the message, through encryption and generates a corresponding license key for each subscriber on a list of distribution, in step 418.

The protected content along with the corresponding license keys are returned to the TN 302 in step 420. The TN 302 then stores the DRM-protected message in the MS 306 in step 422. An acknowledgment is issued from the MS 306 to the TN 302, in step 424.

In step 426, a MMS notification is pushed from the TN 302 to the subscriber A 314 for informing the subscriber A 314 about the message of the viral campaign.

In step 428, subscriber A 314 sends an acknowledgment for the notification to the TN 302 and then in step 430 sends a MMS message to the TN 302 to request the message of the viral campaign.

In step 432, the subscriber A 314 opens the MMS message and then in step 434 requests its corresponding license key from the license server 22 in order to open the content of the message of the viral campaign.

In step 436, the license server 22 finds the appropriate/corresponding license key and then sends it to the Short Messaging Service Center (SMS-C) 318, for example, as a binary SMS, in step 438. It is assumed that subscriber A 314 belongs to the list of distribution.

It should be noted that through the request and granting of the license key, a report can be produced for the viral campaign by the MMC 12. The ID of the subscriber A 314 requesting the license key is correlated with the ID of the content of the message of the viral campaign for example. Thus, it is possible to track how many people/subscribers have downloaded and opened the content of the message through the granting of the license key.

The binary SMS containing the license key is sent to the subscriber A 314 in step 440. Upon receipt of the binary SMS, the subscriber A 314 applies the license key to his/her mobile device 18 and thus can open the content of the message of the campaign, in step 442. It should be noted that other sending means are also possible for transmitting the corresponding license key to the subscriber A 314. It is not restricted to SMS.

After the subscriber A 314 opens the content of the message, which can be text, video, image, etc., he/she likes it and desires to share it with subscriber B 316.

In his/her desire to forward the MMS containing the message of the viral campaign to subscriber B 316, the MMS first goes to the TN 302, in step 444.

The TN 302 asks the MS 306 to store it, in step 446. An acknowledgment is issued from the MS 306 to the TN 302, in step 448. Then, in step 450, the TN 302 opens the MMS and performs a correlation between the content ID and the ID of the viral campaign to make sure that the content ID belongs to the current viral campaign.

In step 452, a MMS notification is pushed to the subscriber B 316, to which the subscriber B 316 replies with an acknowledgment and requests for the message in step 454.

In step 456, the subscriber B 316 opens the received MMS message. Then, she/he asks for the license key in step 458 from the license server 22.

The license server 22, upon receipt of the request, asks the DRM module 14 to generate the license key based on the mobile device of subscriber B 316. In this case, it is assumed that subscriber B 316 is not part of the list of distribution, therefore no corresponding license key was pre-generated for him/her. Once the license key is generated, the license key is sent to the license server 22, which receives the license key in step 460. Then in step 462, the license server 22 sends the license key as a binary SMS, for example, to the subscriber B 316.

In step 466, the subscriber B 314 opens the content of the message upon receipt of the license key. The subscriber B 316 can then forward the message to further subscribers using the same steps (steps 444 to 466) as described hereinabove, for example.

It should be noted that when each subscriber retrieves the license key from the license server 22, a correlation of the license key (having a serial number, for example) and the MSISDN of the subscriber is made, as well as a correlation between the license key and the message. The correlation can be then documented in a report. The report can be transmitted to the content provider 16 at the end of the viral campaign.

Thus, it is now possible to track how many people have read each message of the campaign and how many messages each subscriber of the distribution list has forwarded to other people. Also, each message can be tracked so as to indicate where the message comes from and where it is forwarded to, for example.

By so doing, a better feedback and measure of success of the viral campaign can be achieved.

Another context for embodiments of the present invention is concerned with sharing multimedia contents, such as music or movies, among at least a first and second subscribers.

Usually, such contents are protected by DRM. So, when a user downloads a multimedia content, from a web site, for example, he/she keeps it for himself/herself. The user cannot share his/her download with friends. Also, often times, it can be cumbersome and long to download a multimedia content from the content provider, through the web site.

However, using an embodiment of the present invention, it is possible for a subscriber to share his/her downloaded content protected by DRM with other friends. To do so, each subscriber who gets a copy of the content, through the forwarding of another subscriber, still needs to get a key from a license server in communication with a DRM module in order to be able to render the content. However, instead of going himself/herself to the web site to download the content, the subscriber can get the content from a friend of his/hers, for example.

It should be noted that embodiments of the present invention can be also applied to track voice messages in Mobile communications Over Internet Protocol (MoIP).

As mentioned previously, it is not possible to generate a report to accurately charge for an advertisement campaign through prior solutions. Likewise, top subscribers that distribute an advertisement campaign cannot be rewarded.

The present invention enhances tracking of peer distribution of a content in a network. By doing so, charging the content provider can be enhanced and subscribers that forward content can also be rewarded, for instance, by receiving credits or other advantages. Subscriber that forward content can also be specifically marked in lists of distribution for future campaign.

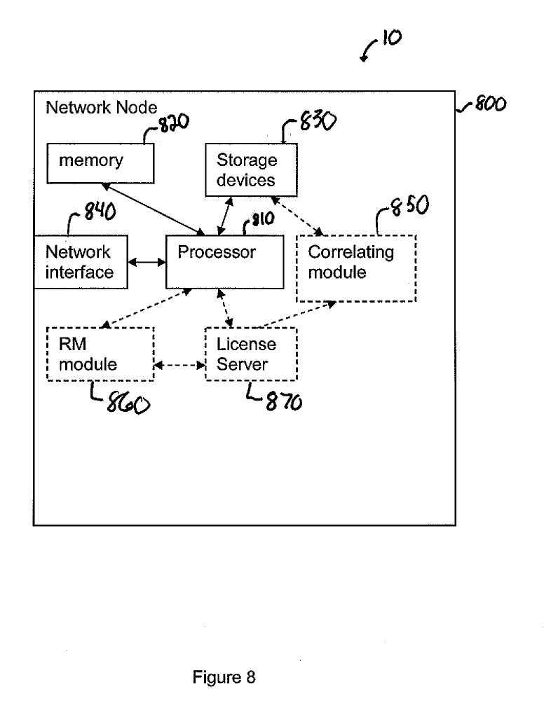

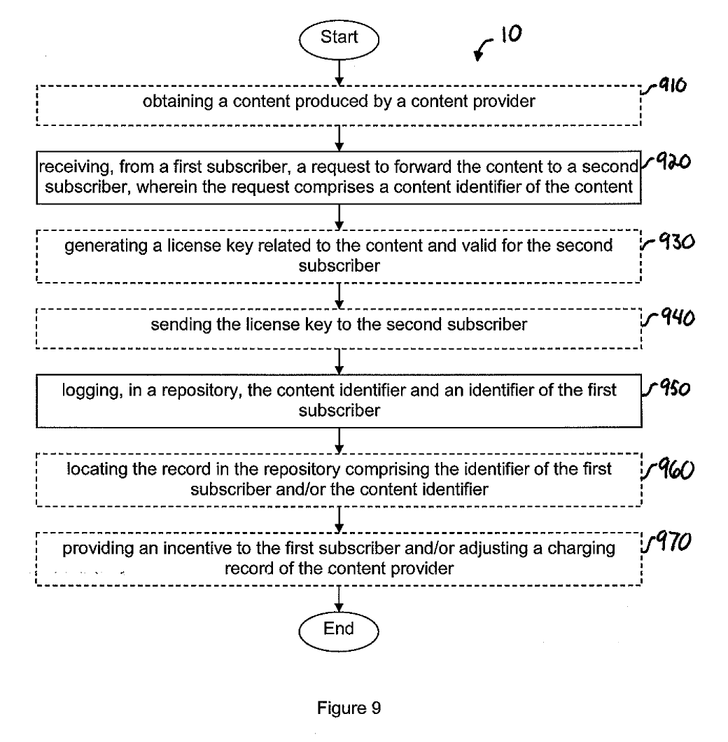

On FIGS. 8 to 10, optional elements are shown in dotted lines. FIG. 9 shows an exemplary flow chart illustrating a method for enhancing tracking of peer distribution of a content in the network 10 in accordance with the teachings of the present invention. The first step shown in the example of FIG. 9 is obtaining a content produced by a content provider 16 (step 910). Step 910 may be performed in many different ways and the present invention is not limited thereby. The method follows with a step of receiving, from a first subscriber, a request to forward the content to a second subscriber 920. The request comprises a content identifier of the content. Optionally, the method may then follow with generation of a license key related to the content and valid for the second subscriber 930. If generated, the license key may also be sent 940 to the second subscriber. The method then specifies a step of logging 950, in a repository, the content identifier and an identifier of the first subscriber. An identifier of the second subscriber may also be logged in step 940.

Afterward, the method may further comprise a step of locating the record in the repository (step 960). Locating the record may be performed in many different ways without affecting the present invention. For instance, the step of locating the record 960 is likely affected by how data records are stored or organized in the repository and by the language used to access the record from the repository. The step of locating the record 960 may comprise retrieving the actual record (e.g., sending partial or complete record from the repository to another node) or simply involved verifying that the record exists.

Furthermore, the step of locating the record 960 may actually involve locating more than only one record in the repository. For instance, the condition used in step 960 may specify that n records need to be located.

In the exemplary scenario of FIG. 9, there are different purposes for the step of locating the record 960. The step of locating the record 960 may be performed to locate the record because it mentions the content identifier, because it mentions the first subscriber identifier or because it mentions both the first subscriber identifier and the content identifier.

The purpose of locating the record because it mentions at least the identifier of the first subscriber may be for report purpose only. It may involve fine tuning existing distribution lists or creating new distribution lists. It may also involve providing an incentive to the first subscriber (step 970). The step of providing the incentive 970 may be triggered based on a single record, but may also involve n record that each comprise at least the identifier of the first subscriber or has been logged because of the request to forward (i.e., the second subscriber that received the content because of the first subscriber further forwarded the content to other subscriber).

Examples of how the step of providing the incentive may be performed involved one or many of the following items:

a) giving customer loyalty points to the first subscriber (e.g., from a program that is owned or subscribed to by the operator of the network or from a program owned or subscribed to by the content provider);

b) crediting a charging record of the first subscriber in the network (e.g., deducting an amount of money to the first subscriber on an invoice or adding money to a pre-paid account of the first subscriber, etc.);

c) increasing a data threshold of the first subscriber in the network (e.g., increasing the download limit of the first subscriber from 6 Gb per month to 12 Gb per month past a certain number of records or increasing by an amount that is linked to the number of forwards and the evaluated size of the content forwarded);

d) decreasing a data consumption account of the first subscriber in the network (e.g., decreasing the consumed data account of the first subscriber by an amount that is linked to the number of forwards and the evaluated size of the content forwarded);

e) associating the first subscriber to a higher Quality of service (QoS) profile in the network;

f) modifying a data charging rate for the first subscriber in the network;

g) modifying a voice charging rate for the first subscriber in the network;

h) allowing access to a restricted service to the first subscriber (e.g., the restricted service may be offered through the network by the content's provider or be a service of the network not linked to the content provider); and/or

i) waiving an account restriction for the first subscriber in the network temporarily or permanently (e.g., restriction based on the type of content made available to or made available from the first subscriber (related or not to the forwarded content), restriction on type of activities permitted linked on time of day/day of week, etc.).

The step 970 of providing the incentive may also involve, alternatively in conjunction with one or many of a) to i), sending at least one message towards a network node to perform at least one of a) to i).

As mention earlier, the purpose of locating the record may be because it mentions at least the content identifier. This may be performed for report purpose only. It may also involve adjusting a charging record of the content provider in the network (step 970).

FIG. 8 shows an exemplary modular representation of a network node 800 for enhancing tracking of peer distribution of a content in the network 10 in accordance with the teachings of the present invention. The network node 800 comprises a processor module 810, a memory module 820, and a network interface module 840 and comprises or, otherwise makes available to its other modules, a storage devices module 830.

The processor module 810 may represent a single processor with one or more processor cores or an array of processors, each comprising one or more processor cores. The memory module 820 may comprise various types of memory (different standardized or kinds of Random Access Memory (RAM) modules, memory cards, Read-Only Memory (ROM) modules, programmable ROM, etc.). The storage devices module 830 may represent one or more logical or physical as well as local or remote hard disk drive (HDD) (or an array thereof). The storage devices module 830 may further represent a local or remote database made accessible to the network node 800 by a standardized or proprietary interface. The network interface module 840 represents at least one physical interface that can be used to communicate with other network nodes. For the sake of simplicity, the following example related to the network node 800 will refer to a repository to represent the various means that can be used to store records. The network interface module 840 may be made visible to the other modules of the network node 800 through one or more logical interfaces. The actual stacks of protocols used by the physical network interface(s) and/or logical network interface(s) of the network interface module 840 do not affect the teachings of the present invention. The variants of processor module 810, memory module 820, network interface module 840 and storage devices module 830 usable in the context of the present invention will be readily apparent to persons skilled in the art. Likewise, even though explicit mentions of the memory module 820 and/or the processor module 810 are not made throughout the description of the present examples, persons skilled in the art will readily recognize that such modules are used in conjunction with other modules of the network node 800 to perform routine as well as innovative steps related to the present invention.

The network node 800 may also optionally comprise a correlating module 850, a Rights Management (RM) module 860 and a license server module 870.

The network interface module 840 is for receiving, from a first subscriber, a request to forward the content to a second subscriber. The request to forward comprises a content identifier of the content. The repository is for logging in a record at least the content identifier and an identifier of the first subscriber. The record may further comprise an identifier of the second subscriber

Optionally, the license server module 970 will be used for, following reception of the request, generating a license key related to the content and valid for the second subscriber, wherein logging the record is performed following generating the license key.

As another option, the correlating module 850 may be used for locating the record in the repository comprising the identifier of the first subscriber and following locating the record, providing an incentive to the first subscriber (examples of incentive have already been given). The network interface may also be used for sending at least one message from therethrough towards another network node to partially or completely provide the incentive.

The correlating module 850 may also be used for locating at least n records in the repository wherein each of the n records comprises at least the identifier of the first subscriber or has been logged because of the request to forward

The network interface module 840 may also be further used for obtaining the content produced by a content provider. The RM module 860 may or not be used to protect the content. The correlating module 850 may also be used for locating the record in the repository comprising the content identifier and adjusting a charging record of the content provider in the network. The adjustment to the charging record of the content provider may further be performed taking into account that the record comprises the identifier of the first subscriber.

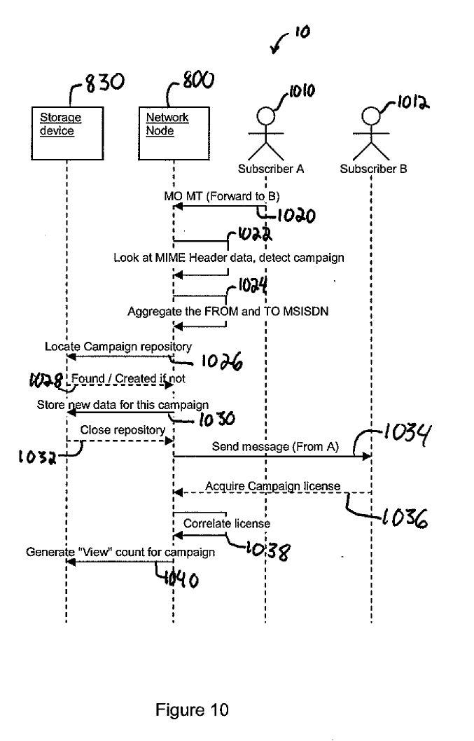

FIG. 10 shows an exemplary flow chart illustrating a detailed method for enhancing tracking of peer distribution of a content in the network 10 in accordance with the teachings of the present invention. The Network Node 800 is shown separately from the Storage Devices module 830. Two subscribers A (1010) and B (1012) are also shown on FIG. 10.

In the example shown on FIG. 10, it is assumed that a content is protected by rights management and has been previously made available to A 1010. FIG. 10 starts with a request to forward of a content from A 1010 to B 1012 shown as a MO MT (Forward to B) message (1020) sent from A 1010 to the network node 800. The message 1020 comprises enough information for the network node 800 to identify A 1010, B 1012 and the content to be forwarded. In the example of FIG. 10, A 1010 and B 1012 each have an associated MSISDN. The message 1020 may actually comprise the content itself. It may also comprise an identifier of a content provider and/or of a specific advertisement campaign. In the example of FIG. 10, the message 1020 comprises a campaign identifier.

Upon reception of the message 1020, the network node analyses a header of the message 1020 (e.g., MIME Header data) and detect that the message 1020 is related to the campaign (step 1022). The network node then aggregates the FROM (A 1010) and TO (B 1012) MSISDN (step 1024). The network node then locates a related campaign repository (step 1026) in the storage device 830. The storage device 830 creates (if needed) and returns information to the network node 800 (1028) concerning the related campaign repository.

The network node 800 then instructs the storage device 830 to store new data for this campaign (1030). In the example of FIG. 10, the new data comprises an identifier of the content or of the related campaign, an identifier of A 1010 and an identifier of B 1012. The storage device 830 may then inform the network node 800 that the related repository is closed (1032)

The network node 800 then send the content (forwarded from A 1010) towards B 1012 (step 1034). If not previously obtained, B 1012 may then acquire a relevant campaign license (1036) necessary to open the forwarded content.

At any time afterwards, the network node 800 may require to correlate information related to the campaign (1038). The network node 800 therefore requests the storage device 830 to generate “View” count for the relevant campaign. The view can contain different level of information and may be used for many different purposes, as exemplified previously.

Modifications and other embodiments of the disclosed invention will come to mind to one skilled in the art having the benefit of the teachings presented in the foregoing description and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method for enhancing tracking of peer distribution of a content in a network, the method comprising steps of:
receiving, from a first subscriber, a request to forward the content to a second subscriber, wherein the request comprises a content identifier of the content; and
logging, in a record stored in a memory of a repository, the content identifier and an identifier of the first subscriber.

2. The method of claim 1 wherein the record further comprises an identifier of the second subscriber

3. The method of claim 1 further comprising steps of:
following the step of receiving the request, generating a license key related to the content and valid for the second subscriber;
sending the license key to the second subscriber; and
providing the content to the second subscriber, wherein the step of logging is performed following the step of generating.

4. The method of claim 1 further comprising steps of:
locating the record in the repository comprising the identifier of the first subscriber; and
following the step of locating, providing an incentive to the first subscriber.

5. The method of claim 4 wherein the step of providing an incentive to the first subscriber comprises at least one of:
a) giving customer loyalty points to the first subscriber;
b) crediting a charging record of the first subscriber in the network;
c) increasing a data threshold of the first subscriber in the network;
d) decreasing a data consumption account of the first subscriber in the network;
e) associating the first subscriber to a higher Quality of service (QoS) profile in the network;
f) modifying a data charging rate for the first subscriber in the network;
g) modifying a voice charging rate for the first subscriber in the network;
h) allowing access to a restricted service to the first subscriber, wherein the restricted service is offered through the network by the content's provider; or
i) waiving an account restriction for the first subscriber in the network; or
sending at least one message from the repository's network node towards another network node to perform at least one of a) to i).

6. The method of claim 1 further comprising steps of:
locating at least n records in the repository, the n records comprising the record, wherein each of the n records:
comprises at least the identifier of the first subscriber; or
has been logged because of the request to forward; and
following the step of locating, providing an incentive to the first subscriber.

7. The method of claim 1 further comprising steps of:
before the step of receiving, obtaining the content produced by a content provider;
following the step of logging, locating the record in the repository comprising the content identifier; and
following the step of locating, adjusting a charging record of the content provider in the network.

8. The method of claim 7 wherein the step of adjusting the charging record of the content provider is performed taking into account that the record comprises the identifier of the first subscriber.

9. The method of claim 1 further comprising a step of, before receiving the request to forward from the first subscriber, obtaining the content by the first subscriber from one of the content' provider or a third subscriber of the network.

10. A network node for enhancing tracking of peer distribution of a content in a network, the network node comprising:
a network interface for receiving, from a first subscriber, a request to forward the content to a second subscriber, wherein the request comprises a content identifier of the content; and
a repository for logging in a record the content identifier and an identifier of the first subscriber.

11. The network node of claim 10 wherein the record further comprises an identifier of the second subscriber

12. The network node of claim 10 further comprising a license server module for:
following reception of the request, generating a license key related to the content and valid for the second subscriber, wherein logging the record is performed following generating the license key.

13. The network node of claim 10 further comprising a Correlating Module for:
locating the record in the repository comprising the identifier of the first subscriber; and
following locating the record, providing an incentive to the first subscriber.

14. The network node of claim 13 wherein providing an incentive to the first subscriber comprises at least one of:
a) giving customer loyalty points to the first subscriber;
b) crediting a charging record of the first subscriber in the network;
c) increasing a data threshold of the first subscriber in the network;
d) decreasing a data consumption account of the first subscriber in the network;
e) associating the first subscriber to a higher Quality of service (QoS) profile in the network;
f) modifying a data charging rate for the first subscriber in the network;
g) modifying a voice charging rate for the first subscriber in the network;
h) allowing access to a restricted service to the first subscriber, wherein the restricted service is offered through the network by the content's provider; or
i) waiving an account restriction for the first subscriber in the network; or
sending at least one message from through the network interface towards another network node to perform at least one of a) to i).

15. The network node of claim 10 further comprising a Correlating Module for:
locating at least n records in the repository, the n records comprising the record and, wherein each of the n records:
comprises at least the identifier of the first subscriber; or
has been logged because of the request to forward; and
following locating the at least n records, providing an incentive to the first subscriber.

16. The network node of claim 10 wherein:
the network interface is further for obtaining the content produced by a content provider; and
the network node further comprise a Correlating Module for:
following logging of the record, locating the record in the repository comprising the content identifier; and
following locating the record, adjusting a charging record of the content provider in the network.

17. The network node of claim 16 wherein adjusting the charging record of the content provider is performed taking into account that the record comprises the identifier of the first subscriber.
